(19) United States
(12) Patent Application Publication
(10) Pub. No.: US 2014/0325279 A1
(43) Pub. Date: Oct. 30, 2014

(54) TARGET FAILURE BASED ROOT CAUSE ANALYSIS OF NETWORK PROBE FAILURES

(71) Applicant: Hewlett-Packard Development Company, L.P., (US)

(72) Inventors: Muthukumar Suriyanarayanan, Bangalore (IN); Srikanth Natarajan, Fort Collins, CO (US); Nithin Jose, Bangalore (IN)

(73) Assignee: Hewlett-Packard Development Company, L.P., Houston, TX (US)

(21) Appl. No.: 13/872,934

(22) Filed: Apr. 29, 2013

(51) Int. Cl. G06F 11/07

(52) U.S. Cl. CPC G06F 11/079
USPC 714/37

(57) ABSTRACT

Provided is a method of performing a target failure based root cause analysis of network probe failures in a computer network. A determination is made whether all network probes have failed between a specific source network node and a destination network node. Based on said determination, a problem is identified in the computer network.

### BACKGROUND

Computer networks form the backbone of most modern day information technology (IT) environment of business organizations. Whether it's a company intranet or a Virtual Private Network (VPN) over the internet, computer networks are used for sharing a variety of data such as text, audio, and video. In addition, a large number of business services or processes such as enterprise cloud services, communication solutions, security services, information management services, data center services, business process outsourcing services, etc. are provided over computer networks. In fact most e-commerce business models are based on delivery of timely and efficient services over computer networks. Considering their significance for businesses, computer networks are expected to provide a certain level of service.

### BRIEF DESCRIPTION OF THE DRAWINGS

For a better understanding of the solution, embodiments will now be described, purely by way of example, with reference to the accompanying drawings, in which:

FIG. 1 is a block diagram of a system for performing a Root Cause Analysis (RCA) of network probe failures in a computer network, according to an example.

FIGS. 2A to 2E illustrate a method of performing a Root Cause Analysis (RCA) of network probe failures in a computer network, according to an example.

FIGS. 3A and 3C illustrate a method of performing a Root Cause Analysis (RCA) of network probe failures in a computer network, according to an example.

FIGS. 4A and 4C illustrate a method of performing a Root Cause Analysis (RCA) of network probe failures in a computer network, according to an example.

### DETAILED DESCRIPTION OF THE INVENTION

As mentioned earlier, computer networks may form a key IT component of business organizations. In view of their importance, computer networks are expected to provide a specified level of service. Various mechanisms are available that can monitor the quality of service levels of a network to ensure network services are performing to the desired levels. One such mechanism is to configure a network probe (or multiple network probes) on a network device (for example, a router) to monitor various performance related aspects of a network. For example, network probes may monitor network related parameters such as reachability, latency, jitter, packet loss, amount of network traffic, availability of a network path, etc.

Network probes may share the information collected by them pertaining to various performance related aspects of a network with a network management application or system. Thus, they serve to provide a useful guidance to a user (such as a network administrator) on the general state and health of a network. However, the failure of a network probe does not by itself provide any useful information to an end-user although it may result in loss of network information which was being monitored and shared by the failed network probe.

Failure of a network probe may result in the generation of an incident (or an event). In case a network node breaks down (for instance due to equipment malfunction or other reasons), then all probes associated with the node may fail. This could result in generation of multiple incidents. To provide another example, if there is a reachability failure from one site to another site, this may also result in generation of multiple failure incidents. In both aforementioned scenarios, failure of a network probe(s) does not provide any information to a user for him to identify the root cause of the actual problem in the network. In other words, it is not possible for a user to pin point the actual failure from such incidents. There's no existing solution that deduces target failures or destination faults in combination with the probes failure.

Proposed is a solution that performs a target failure based Root Cause Analysis (RCA) of network probe failures in a computer network to identify the causal problem. The solution provides more insight into a network probe failure by trying to find out the root cause of the failure by correlating Incident (or event) information with network topology information. The Root Cause Analysis (RCA) would help a user to find out the “root cause” of a network outage and other network issues quickly. The solution correlates probe failure with target failures or destination faults which may be used to correct or eliminate the cause, and prevent the problem from reoccurring. Thus, Root Cause Analysis (RCA) could be of two types: (a) when multiple network probes either from same node or going to same destination, an analysis is performed to find out whether the actual problem is at source or destination, and (b) when an interface or node fault occurs, it is mapped back to an already discovered list of probes which are either destined towards the failed node or begin from the failed node.

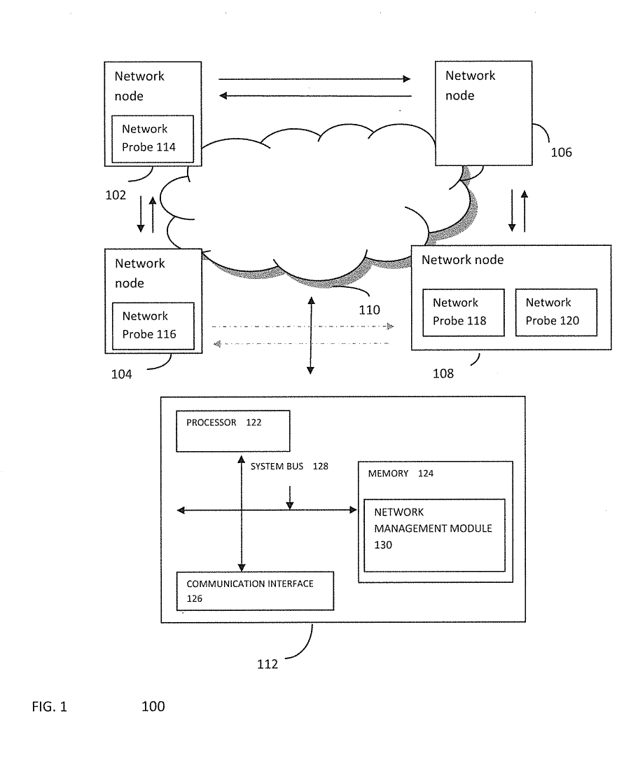

FIG. 1 is a block diagram of a system 100 for performing a Root Cause Analysis (RCA) of network probe failures in a computer network, according to an example. System 100 includes network nodes 102, 104, 106 and 108 in network 110, and computer server 112. Components of system 100 i.e. network nodes 102, 104, 106 and 108, and computer server 112 could be operationally connected over network 110, which may be wired or wireless. Network 110 may be a public network such as the Internet, or a private network such as an intranet. In an implementation, network probes may be deployed in network 110 to monitor various traffic characteristics of network 110. It would be appreciated that the components depicted in FIG. 1 are for the purpose of illustration only and the actual components (including their number) may vary depending on the computing architecture deployed for implementation of the present invention.

Network nodes 102, 104, 106 and 108 could be a physical network node or logical network node. Some non-limiting examples of physical network nodes may include network devices such as a switch, bridge, router, hub, and the like, and other computing devices such as server, workstation, printer, desktop, etc. In an implementation, a network probe may be deployed on a network node(s). FIG. 1 illustrates network probes 114 and 116 configured on network nodes 102 and 104 respectively. A plurality of network probes could also be configured on a single network node. For example, network probes 118 and 120 are configured on network node 108. Network probes may be configured on network nodes via a console (command-line interface) or Simple Network Management Protocol (SNMP). A network node can be a network device, an interface, a Virtual Routing and Forwarding (VRF) instance in a Virtual Private Network (VPN), and the like.

As mentioned earlier, network probes can be used to monitor various performance related aspects of a network. For example, network probes may help in monitoring various network related parameters such as reachability, latency, jitter, packet loss, amount of network traffic, availability of a network path, etc. Network probes could be considered akin to tests configured on network nodes to monitor network traffic. They serve to provide a useful guidance to a user on the general state and health of a network. Network probes could be of various types. Some non-limiting examples of network probes running between Internet Protocol (IP) applications and services include User Datagram Protocol (UDP) echo, UDP jitter, Transmission Control Protocol (TCP) connect, Hypertext Transfer Protocol (HTTP), HTTPs, Domain Name System (DNS), Oracle, Internet Control Message Protocol (ICMP) echo, etc.

Computer server 112 is a computer or computer application (machine executable instructions) that provides services to other computers or computer applications. Computer server 112 may include a processor 122, a memory 124, and a communication interface 126. The components of computer server 112 may be coupled together through a system bus 128. Processor 122 may include any type of processor, microprocessor, or processing logic that interprets and executes instructions. Memory 124 may include a random access memory (RAM) or another type of dynamic storage device that may store information and instructions non-transitorily for execution by processor.

In an implementation, memory 124 includes network management application (machine executable instructions) or module 130. Network management module 130 may be configured to monitor network 110 and various network resources such as network nodes 102, 104, 106 and 108. Network management module 130 may also be configured to monitor quality of service levels of network 110 to ensure network services are performing to the desired levels. In an implementation, said monitoring may be performed by discovering network probes (such as 114, 116 and 118) configured on network devices such as network nodes 102, 104, 106 and 108, and monitoring the results of the probes to deduce the health of network 110. Thus, network probe(s) deployed on a network may be managed and monitored by network management module 130 or a component thereof such as a plug-in. In an implementation, network management module performs a root cause analysis of network probe failures in a computer network. It determines whether all network probes have failed between a specific source network node and a destination network node, and based on said determination, identifies a problem in the computer network.

Network management application 130 may include a Graphical User Interface (GUI) to display network probe results and deviations from the desired service levels.

Network management application 130 may discover and monitor probes configured within a local “site” as well as outside. The term “site” in the present context may be defined as a useful way to logically categorize network nodes into groups. For example, a site can be created based on the geographic proximity of the network nodes, similar node groups, IP address ranges, probe name patterns, VRFs, or similar node IDs. In the scope of enterprise networks, a site can be a logical grouping of networking devices generally situated in similar geographic location. The location can include a floor, building or an entire branch office or several branch offices which connect to head quarters or another branch office via for instance a Wide Area Network (WAN). Each site is uniquely identified by its name. In case of the service provider networks, the Virtual Routing and Forwarding (VRF) on a Provider Edge (PE) router or Customer Edge (CE) routers may be considered as a site.

Communication interface 126 may include any transceiver-like mechanism that enables computer server 112 to communicate with other devices and/or systems via a communication link. Communication interface 126 may be a software program, a hard ware, a firmware, or any combination thereof. Communication interface 126 may use a variety of communication technologies to enable communication between computer server and another computing device. To provide a few non-limiting examples, communication interface may be an Ethernet card, a modem, an integrated services digital network (“ISDN”) card, a network port (such as a serial port, a USB port, etc.) etc.

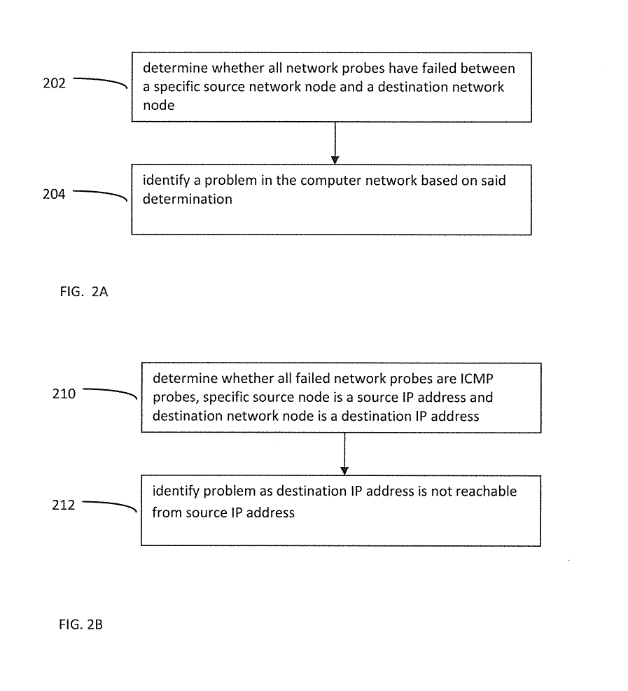

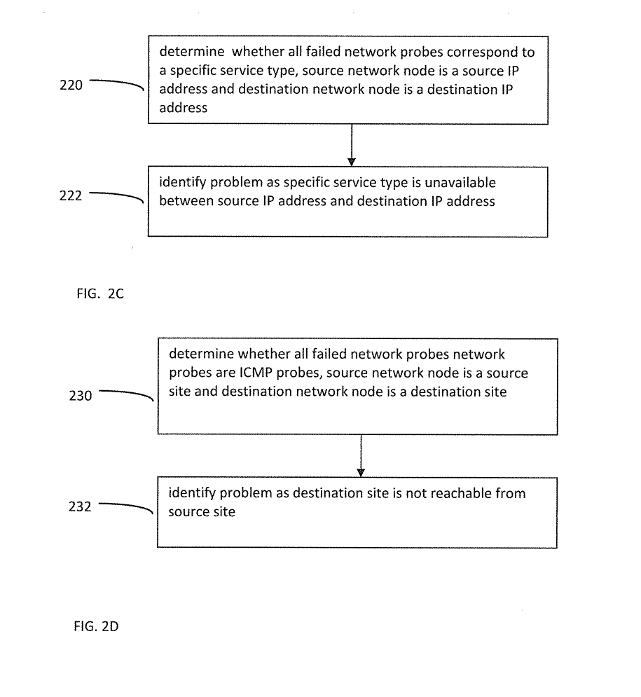

FIG. 2A illustrates a method of performing a Root Cause Analysis (RCA) of network probe failures in a computer network, according to an example. At block 202, a determination is made if all network probes have failed between a specific source network node and a destination network node in a computer network. In other words, a source network node (for example, a router) and a destination network node (for example, another router) are selected in a computer network, and a test is performed to ascertain whether all network probes fail between the selected source network node and the destination network node. It may be noted that general reachability failures may be calculated using Internet Control Message Protocol (ICMP) probes. Since ICMP is the lowest service in the IP service stack, an ICMP probe failure inculcates that all other services would also fail. In such case, the ICMP failure is identified as the primary cause. Aforementioned scenario applies to both source and destination ICMP failures.

At block 204, based on determination made at block 202, if it is identified that all network probes have failed between a specific source network node and a destination network node in a computer network then a problem that might have caused such failure in the computer network is identified. In other words, the root cause of the failure of all network probes between a specific source network node and a destination network node is carried out. Said differently, a Root Cause Analysis (RCA) of network probe failures is performed to identify what might have led to such failures. Thus, network probes failures are evaluated to provide useful information to an end-user.

Various kinds of failures may be deduced upon determination that all network probes have failed between a specific source network node and a destination network node in a computer network. In an instance (illustrated in FIG. 2B), if all failed network probes are Internet Control Message Protocol (ICMP) probes, the source network node is a source IP address and the destination network node is a destination IP address (210) then a cause behind said failures could be that the destination IP address is not reachable from the source IP address (212). In other words, an inference may be made that there's a reachability failure from a source node to a destination node, and the destination node is not reachable from the source node. For the sake of clarity, it may be note that ICMP is a network protocol which is typically used to identify errors in the underlying communications of network applications and availability of remote hosts.

In another instance (illustrated in FIG. 2C), if all failed network probes correspond to a specific service type, the source network node is a source IP address and the destination network node is a destination IP address (220) then the reason behind said failures could be that the specific service type is unavailable between the source IP address and the destination IP address (222). Thus, in this case, failed network probes belong to service types other than ICMP. Some non-limiting examples of service types may include User Datagram Protocol (UDP), Transmission Control Protocol (TCP), Hypertext Transfer Protocol (HTTP), HTTPS, and Domain Name System (DNS).

In a further instance (illustrated in FIG. 2D), if all failed network probes are Internet Control Message Protocol (ICMP) probes, the source network node is a source site and the destination network node is a destination site (230) then an inference may be made that the reason behind said failures could be that the destination site is not reachable from the source site (232).

In a yet another instance (illustrated in FIG. 2E), if all failed network probes correspond to a specific service type, the source network node is a source site and the destination network node is a destination site (240) then a conclusion may be reached that the reason behind said failures could be that the specific service type is unavailable between the source site and the destination site (242).

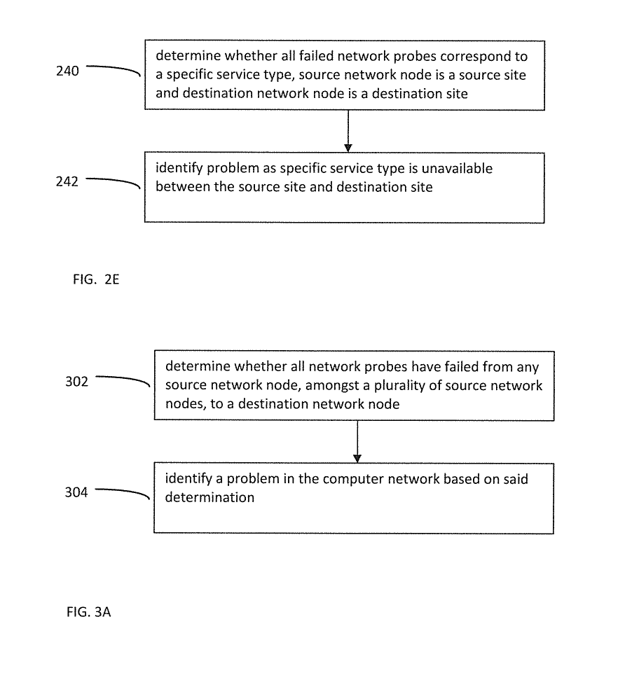

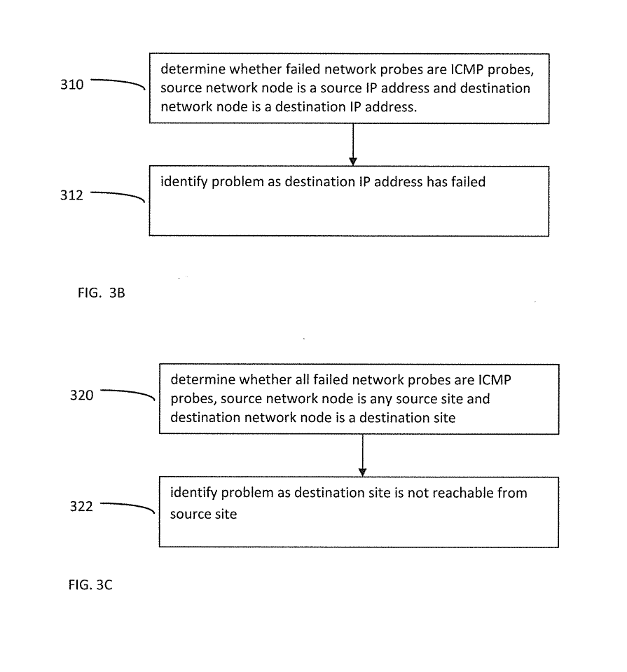

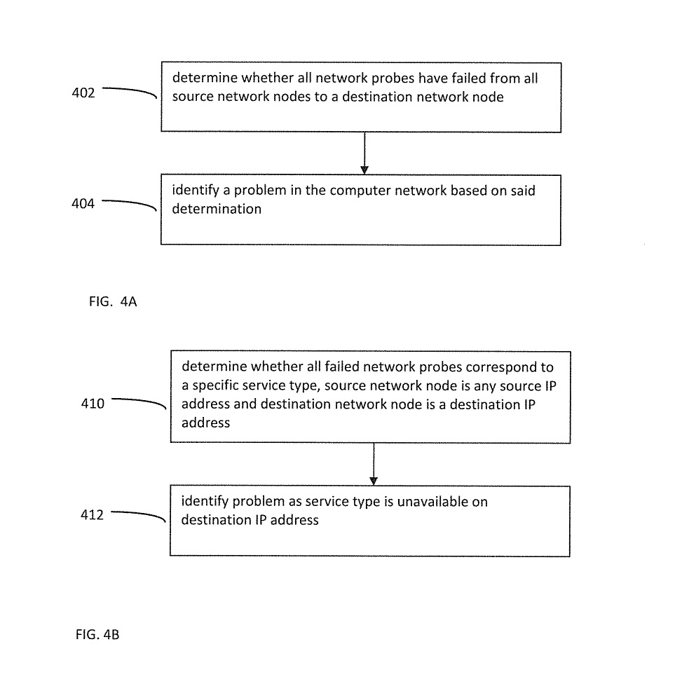

FIG. 3A illustrates a method of performing a Root Cause Analysis (RCA) of network probe failures in a computer network, according to an example. At block 302, a determination is made whether all network probes have failed from any source network node to a specific destination network node in a computer network. In other words, it is determined whether all network probes between a “designated” network source node and a destination node fail. To provide an illustration, let's assume that a router “E” is a destination node in a computer network. Then irrespective of selection of any router as source network node (for instance, it could be router “A”, “C”, “D”, etc.), it is ascertained whether all network probes from a selected source network node to the destination network node (router “E”) have failed.

At block 304, based on determination made at block 302, if it is identified that all network probes have failed from any source network node to a destination network node in a computer network then a problem that might have caused such failure in the computer network is identified. In other words, the root cause of the failure of all network probes between a specific source network node and a destination network node is carried out.

A variety of failures may be inferred upon determination that all network probes have failed from a specific source network node to a destination network node in a computer network. In an instance (illustrated in FIG. 3B), if all failed network probes are Internet Control Message Protocol (ICMP) probes (310), the source network node is a source IP address and the destination network node is a destination IP address, then a conclusion may be reached the reason behind said failures could be that the destination IP address has failed (312).

In another instance (illustrated in FIG. 3C), if all failed network probes are ICMP probes, the source network node is any source site and the destination network node is a destination site (320), then an inference may be made that the reason for said failures could be that the destination site is not reachable from the source site.

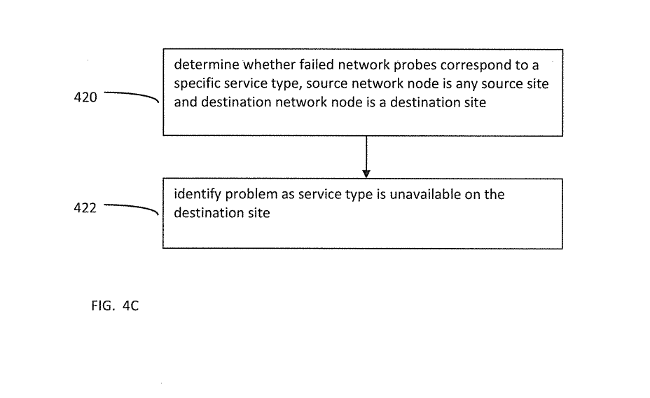

FIG. 4A illustrates a method of performing a Root Cause Analysis (RCA) of network probe failures in a computer network, according to an example. At block 402, a determination is made whether all network probes have failed from all “source” network nodes to a specific destination network node in a computer network. To provide an illustration, let's assume that a network has five network nodes. These may be different routers which are labeled as “A”, “B”, “C”, “D” and “E”. If router “E” is a destination node in a computer network. Then a determination is made whether all network probes from all selected source network nodes (for instance, routers “A”, “B” “C”, and “D”) to the destination network node (router “E”) have failed.

At block 404, based on determination made at block 402, if it is identified that all network probes have failed from all source networks node to a destination network node in a computer network then a problem that might have caused such failure in the computer network is identified. In other words, the root cause of the failure of all network probes between a specific source network node and a destination network node is carried out.

Various failures may be inferred upon determination that all network probes have failed from all source network nodes to a destination network node in a computer network. In an instance (illustrated in FIG. 4B), if all failed network probes network probes correspond to a specific service type, the source network node is any source IP address and the destination network node is a destination IP address (410) then the reason behind said failures could be that the service type is unavailable on the destination IP address (412).

In another instance (illustrated in FIG. 4C), if all failed network probes correspond to a specific service type, the source network node is any source site and the destination network node is a destination site (420) then a conclusion could be made that the service type is unavailable on the destination site (422). Some non-limiting examples of service types may include User Datagram Protocol (UDP), Transmission Control Protocol (TCP), Hypertext Transfer Protocol (HTTP), HTTPS, and Domain Name System (DNS).

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in the illustrated figures are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of performing a target failure based root cause analysis of network probe failures in a computer network, comprising:
determining whether all network probes have failed between a specific source network node and a destination network node; and
identifying a problem in the computer network based on said determination.

2. The method of claim 1, wherein the network probes are ICMP probes, the specific source node is a source IP address and the destination network node is a destination IP address.

3. The method of claim 2, wherein the identified problem includes that the destination IP address is not reachable from the source IP address.

4. The method of claim 1, wherein the network probes correspond to a specific service type, the source network node is a source IP address and the destination network node is a destination IP address.

5. The method of claim 4, wherein the identified problem includes that the specific service type is unavailable between the source IP address and the destination IP address.

6. The method of claim 1, wherein the network probes are ICMP probes, the source network node is a source site and the destination network node is a destination site.

7. The method of claim 6, wherein the identified problem includes that the destination site is not reachable from the source site.

8. The method of claim 1, wherein the network probes correspond to a specific service type, the source network node is a source site and the destination network node is a destination site.

9. The method of claim 8, wherein the identified problem includes that the specific service type is unavailable between the source site and the destination site.

10. A method of performing a target failure based root cause analysis of network probe failures in a computer network, comprising:
determining whether all network probes have failed from any source network node, amongst a plurality of source network nodes, to a destination network node; and
identifying a problem in the computer network based on said determination.

11. The method of claim 10, wherein the network probes are ICMP probes, the source network node is a source IP address and the destination network node is a destination IP address.

12. The method of claim 11, wherein the identified problem includes that the destination IP address has failed.

13. The method of claim 10, wherein the network probes are ICMP probes, the source network node is any source site and the destination network node is a destination site.

14. The method of claim 13, wherein the identified problem includes that the destination site is not reachable from the source site.

15. A method of performing a target failure based root cause analysis of network probe failures in a computer network, comprising:
determining whether all network probes have failed from all source network nodes to a destination network node; and
identifying a problem in the computer network based on said determination.

16. The method of claim 15, wherein the network probes correspond to a specific service type, the source network node is any source IP address and the destination network node is a destination IP address.

17. The method of claim 16, wherein the identified problem includes that the service type is unavailable on the destination IP address.

18. The method of claim 15, wherein the network probes correspond to a specific service type, the source network node is any source site and the destination network node is a destination site.

19. The method of claim 18, wherein the identified problem includes that the service type is unavailable on the destination site.

20. The method of claim 15, wherein the specific service type includes one of the following: User Datagram Protocol (UDP), Transmission Control Protocol (TCP), Hypertext Transfer Protocol (HTTP), HTTPS, and Domain Name System (DNS).
